(19) United States
(12) Patent Application Publication
(10) Pub. No.: US 2008/0276536 A1
(43) Pub. Date: Nov. 13, 2008

(54) Device for Opening a Rear Window and/or Trunk of a Vehicle

(75) Inventor: Romain Laurens, Clermont-Ferrand (FR)

Correspondence Address: OSHA LIANG L.L.P., 1221 MCKINNEY STREET, SUITE 2800, HOUSTON, TX, 77010, US

(73) Assignee: VALEO SYSTEMES D'ESSUYAGE, Le Mesnil-Saint-Denis (unknown)

(21) Appl. No.: 12/091,656

(22) PCT Filed: Oct. 26, 2006
(86) PCT No.: PCT/EP2006/010316

§ 371 Date: Jun. 19, 2008

(30) Foreign Application Priority Data
Oct. 26, 2005 (FR) 0510906

(51) Int. Cl. E05F 15/00; E05B 65/20; E05F 11/02

(52) U.S. Cl. 49/280; 49/279

(57) ABSTRACT

A device for opening and closing a rear window and/or a trunk of a vehicle is positioned on a periphery of or integrated in a window wiper arm assembly provided on a rear side of the vehicle. The device includes an opening and closing system that comprises a push-button connected to an actuating mechanism. The push-button is integrated on a longitudinal portion of a supporting mount of the window wiper arm assembly, and positioned on a handle integrated on said window wiper arm assembly.

The present invention relates to a device for opening the rear hatch (with a window and/or a trunk) of a vehicle, comprising a system for opening and closing said rear hatch (including a push-button) and a gripping handle.

Some types of vehicles include a rear hatch i.e. a mobile body element hinged either at the rear of the body roof, including the rear window and opening upwards, or at the rear of the floor pan and opening downwards such as on a “pick-up” for example.

By extension, in the common language, the term rear hatch also refers, although improperly, to a rear flap. This means that the rear window can open independently from the trunk, such as on models of the typed called “station wagon” or “sport wagon”.

A device for opening the rear window includes a handle, generally made of two parts and an opening switch.

A first handle system stuck on the rear window and including an opening switch is known from the prior art.

A second system exists according to the prior art where the trunk opening switch is located, for example, close to the number plate or the dashboard. The handles are thus used only for opening the trunk. The handle, according to the prior art, can be stuck on the rear window, mounted about the motor shaft of a window wiper arm assembly, integrated to the window wiper arm assembly or fixed on the body.

However, these known devices have disadvantages.

First, they include a great number of parts. As a matter of fact, a handle which is itself composed of several parts, as well as a complete window wiper arm assembly, must be provided for.

Besides, according to some known devices, the associated electric circuits are positioned outside the vehicle, for example, close to a handle stuck on the rear window. This location results in various electric problems upon opening and closing operations. In order to try and remedy these, additional joints are provided but they do not prevent usual connectics problems which are the main causes of breakdowns for automobile designers.

Besides, such devices, according to the prior art, are not intuitive for the user upon opening or closing the window and/or the trunk, as well as for their fitting or upon changing some constitutive parts.

Besides, they are not aesthetics, because of the additional physical presence of a handle on the rear face of the vehicle.

The present invention remedies the disadvantages of the prior art by providing a device including fewer parts, which represents a reduction in the price and a quicker mounting on the vehicle.

Besides, the device according to the invention is easily manufactured without it being necessary to modify the production line, for low costs as regards raw materials as well as labour.

Besides, the device according to the invention complies with the aesthetic appearance of the vehicles.

Additionally, the device according to the invention has the advantage of being coupled with, or replacing an already existing trunk opening remote control system.

For this purpose, according to the invention, the device for opening and closing the rear window and/or the trunk of a vehicle is characterised in that it is positioned on the periphery of, or it is integrated in a window wiper arm assembly provided on the rear window of said vehicle.

Preferably, it comprises an opening and closing system including a push-button connected to an actuating mechanism.

Advantageously, the push-button can be either integrated on the longitudinal portion of the supporting mount of the window wiper arm assembly, or positioned on a handle integrated on the window wiper arm assembly, or positioned on the side of the distal end of the shaft of the drive motor of said window wiper arm assembly, or positioned close to the window wiper arm assembly, or positioned on the rear window or on the body of the vehicle.

Preferably, the push-button is likely to be actuated by mechanical means or through a remote control system of the IR or radio frequency type, or any other type and it includes a head positioned in the head of the window wiper arm assembly and an actuating rod movable in translation in an axial housing provided in the shaft of the drive motor of the window wiper arm assembly, the distal end of said rod acting on a contactor which triggers an electric switch, which is itself connected by connection means to said motor.

The connection means connecting the push-button with the drive motor are in the form of wires going through an axial housing of the shaft of the motor and may include connection means of the “RJ 45” plug type or any other connection.

Advantageously, the electric system is positioned inside the vehicle by means of a system for fixing said drive motor on the rear window or in the body.

Advantageously, the device comprises a system resetting system upon closing the window and is coupled to a trunk opening remote control system.

The invention will now be better understood while reading the following description, which relates to illustrative and in no way limitative examples of the present invention and referring to the appended drawings:

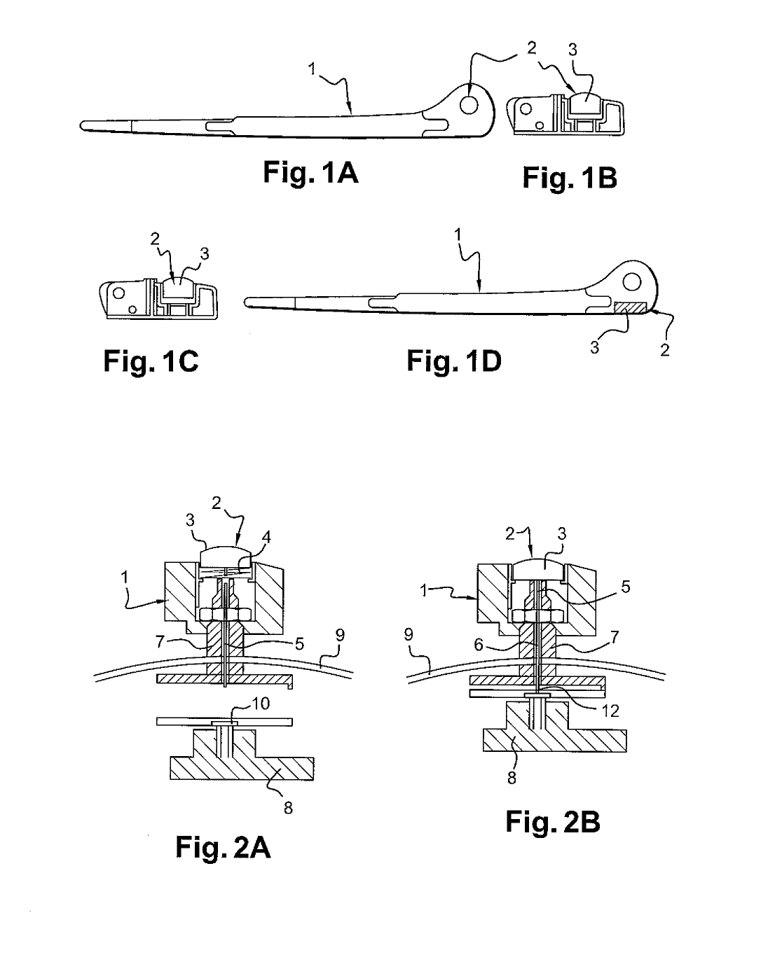

FIGS. 1A and 1B show top and cross-sectional views, respectively, of a first example of the device according to the invention.

FIGS. 1C and 1D show top and cross-sectional views, respectively, of a second example of the device according to the invention.

FIGS. 2A and 2B are cross-sectional representations of a push-button according to the invention in open and closed positions, respectively.

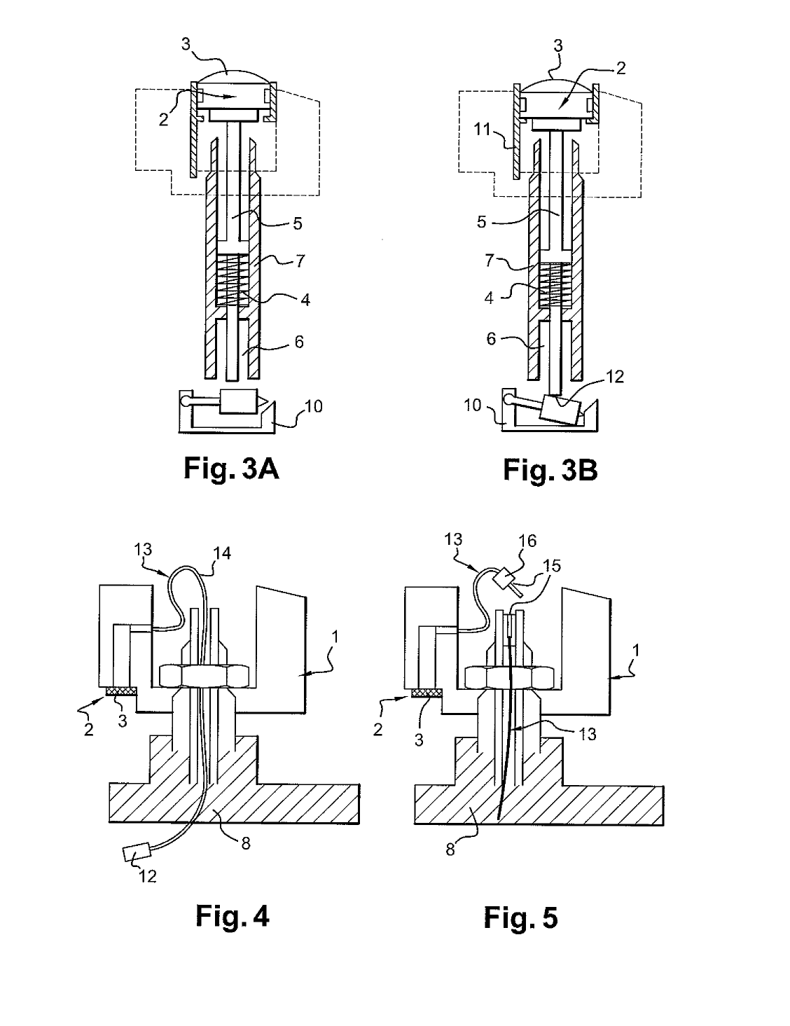

FIGS. 3A and 3B illustrate another embodiment of a push-button, in open and closed positions, respectively.

FIG. 4 is a first embodiment of the connectics connecting the push-button with the drive motor of a window wiper arm assembly.

FIG. 5 is a second embodiment of the connectics connecting the push-button with the drive motor of a window wiper arm assembly.

Referring to FIGS. 1A and 1B, a window wiper arm assembly 1 generally includes a driving arm, a supporting mount, a vertebra and a wiper rubber blade.

In some cases, the handle is provided on the supporting mount (not shown in the Figures).

The device according to the invention is applicable to this position of the handle integrated in the window wiper arm assembly.

A control means 2 for opening and closing the rear window (not shown) according to the invention is integrated on or is positioned on the periphery of the window wiper arm assembly 1. More precisely, this control means 2 for opening and closing the rear window includes a push-button 3.

More preferably, a push-button 3 is integrated in the rear window wiper arm assembly 1.

In an alternative solution, the push-button 3 is positioned for example on the rear window or on the periphery of the window wiper arm assembly 1, or on the longitudinal part of the supporting mount of the wiper assembly 1 or on the handle (not shown) which is itself integrated in the wiper assembly 1.

FIGS. 2A and 2B are cross-sectional representations of another embodiment of a push-button according to the invention in open and close positions, respectively.

The opening and closing means 2 are mechanically operated by the push-button 3 positioned on the periphery of, or integrated in the window wiper arm assembly 1, or electronically operated using a remote control system using an IR or radio frequency type connection, or any other connection type.

The device according to the invention can be fitted as an additional opening device complementary to any other opening button of a known type, which is not positioned on the rear window and which already exists on the vehicle.

The push-button 3 rests on an actuating system or a spring which acts on an actuating mechanism or an acting rod 5. The spring 4 may be positioned upwards or downwards from the rod 5. The rod 5 slides in an axial housing 6 provided in the motor shaft 7 of the drive motor 8 of the wiper arm assembly. The motor shaft 7 goes through the window 9.

The rod 5 (through the window 9) actuates, at its distal end, a contactor which triggers an electric button 10, which is itself connected by connection means (not shown), to the drive motor 8 to enable the opening or the closing of the rear window 9.

In this way, the whole electric system is located inside the vehicle. As a matter of fact, the drive motor 8 is fixed either against the window 9, directly through the motor shaft of the window wiper arm assembly 1, or on the body. When the drive motor 8 is fixed on the body, the motor shaft 7 goes through the window 9.

As the wiper assembly 1 rests against the window 9 when the latter is open, the system according to the invention is not held and is submitted to a rotation force. Then, an internal flange system is provided (known per se and not shown) for resetting the initial position of the driving motor 8.

FIGS. 3A and 3B illustrate another embodiment of an actuator system in open and closed positions, respectively.

The push-button 3 is composed of a body 11 and an action rod 5 positioned between the push-button 3 and the spring 4. The body 11 of the push-button 3 slides in the head of the wiper assembly 1.

Once actuated, the action rod 5, moves in translation in an axial housing 6 provided in the motor shaft 7. The limit position of such operation rod 5 is a point of contact with a contactor 12 connected to the drive motor of the device according to the invention (not shown).

In an alternative solution, a connection between the push-button 3 and the electric button 10 is obtained from the outside of the motor shaft of the window wiper arm assembly; in this case, the connection means go through another axis positioned in the body (not shown).

FIG. 4 shows a first embodiment of the connectics connecting the push-button with the drive motor of the device according to the invention.

The connection means 13 go into the wiper assembly 1 and their paths depend on the position of the push-button 3 on the wiper assembly 1. Preferably, the connection means 13 connecting the push-button 3 with the drive motor 8 may go through the axial housing 6 provided in the motor shaft 7.

The connection means 13 connecting the push-button 3 with the drive motor 8 may be composed of flexible wires 14 of the type known per se. In an alternative solution, the connection means 13 may include a rigid member of the type known per se, through the drive shaft of the wiper arm assembly 1.

FIG. 5 shows a second embodiment of the connectics connecting the push-button with the drive motor of the device according to the invention.

Connection means 15 can also be added through a system of the “RJ 45” type, bearing reference number 16 or any other connection system, of a known type.

The trunk opening control system may also be coupled to the device according to the invention.

Besides, the device according to the invention also makes it possible to replace a trunk opening system, and this is also true for vehicles having no opening rear window.

The device according to the invention may additionally be added even after the window wiper arm assembly 1 has been fitted. As a matter of fact, the wiper assembly which contains or not the device according to the invention has the same external appearance.

1. A device for opening and closing a rear window and/or a trunk of a vehicle, wherein the device is positioned on a periphery of or integrated in a window wiper arm assembly provided on a rear side of said vehicle.

2. The device according to claim 1 comprising:
an opening and closing system comprising a push-button connected to an actuating mechanism.

3. The device according to claim 2, wherein the push-button is integrated on a longitudinal portion of a supporting mount of the window wiper arm assembly.

4. The device according to claim 2, wherein the push-button is positioned on a handle integrated on said window wiper arm assembly.

5. The device according to claim 2, wherein the push-button is positioned on a shaft of a motor of said window wiper arm assembly on a side proximate the distal end of the shaft.

6. The device according to claim 2, wherein the push-button is positioned on a periphery of the window wiper arm assembly.

7. The device according to claim 5, wherein the push-button is positioned on a rear window.

8. The device according to claim 2, wherein the push-button is able to be actuated by mechanical means or through a remote control system of an IR or radio frequency type or any other type.

9. The device according to claim 2, wherein the push-button comprises a head positioned in a head of the window wiper arm assembly, and an actuating rod.

10. The device according to claim 9, wherein the push-button actuates an actuating rod in translation in an axial housing provided in the shaft of the drive motor of a window wiper arm assembly, the distal end of said rod acting on a contactor which triggers an electric switch, which is connected thereof by connecting means to said drive motor.

11. The device according to claim 10, wherein the connection means, connecting the push-button to the drive motor, go through an axial housing of a shaft of the motor.

12. The device according to claim 10 wherein the connection means, connecting said push-button to said drive motor, are in the form of wires.

13. The device according to claim 12, wherein the device comprises connection means of an “RJ 45” plug type or any other connection system.

14. The device according to claim 1, wherein an electric system is positioned inside the vehicle through a system for fixing said drive motor on a rear window or in the body.

15. The device according to claim 1, wherein the device comprises a resetting system upon closing the window.

16. The device according to claim 1, wherein the device is coupled to a trunk opening remote control system.

17. The device according to claim 2, wherein an electric system is positioned inside the vehicle through a system for fixing said drive motor on a rear window or in the body.

18. The device according to claim 2, wherein the device is coupled to a trunk opening remote control system.

19. The device according to claim 3, wherein the push-button is able to be actuated by mechanical means or through a remote control system of an IR or radio frequency type or any other type.

20. The device according to claim 3, wherein the push-button comprises a head positioned in a head of the window wiper arm assembly, and an actuating rod.
